(19) United States
(12) Patent Application Publication
(10) Pub. No.: US 2007/0169047 A1
(43) Pub. Date: Jul. 19, 2007

(54) Scheduling system and method for remotely controlling display device

(75) Inventors: Kee-wook Na, Anyang-si (KR); Gung-eun Nam, Suwon-si (KR); Kwang-yun Na, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/514,951

(22) Filed: Sep. 5, 2006

(30) Foreign Application Priority Data
Oct. 28, 2005 (KR) 2005-0102502

(51) Int. Cl. G06F 9/45

(52) U.S. Cl. 717/151

(57) ABSTRACT

A system and a method for remotely controlling a plurality of display devices connected through a network are provided. The system includes: a remote control scheduling server transmitting a predetermined remote control command to a predetermined display device at a predetermined time; and one or more display devices for executing the remote control command when receiving the remote control command from the remote control scheduling server.

### CROSS-REFERENCE TO RELATED PATENT APPLICATION

This application claims the priority from Korean Patent Application No. 10-2005-0102502, filed on Oct. 28, 2005, in the Korean Intellectual Property Office, the disclosure of which is incorporated herein in its entirety by reference.

### BACKGROUND OF THE INVENTION

1. Field of the Invention

The present invention relates to remote control, and more particularly, to a system and a method for remotely controlling a plurality of display devices connected through a network.

2. Description of the Related Art

Recent technical developments have allowed the use of large display devices to display multimedia content including news, movies, advertisements, announcements, notices, and so on, in airports, department stores, public offices, and schools. When a plurality of display devices are used for these display services, it is difficult to remotely control the display devices. The reason is that the status of each display device must be checked individually, and the power and volume must be controlled manually.

A system for remotely controlling the display devices using a server has been developed by connecting the server to a plurality of display devices so as to effectively control the display system. However, although this allows remote control of power and volume of the display devices, a user must input a control command at the desired time. A timer built into a monitor device is needed so that scheduled jobs such as switching the monitors on and off can be automatically executed when needed.

### SUMMARY OF THE INVENTION

In one aspect, the present invention provides a remote control scheduling system and a method capable of automatically managing a plurality of display devices by scheduling remote control of the display devices. The present invention may also provide a remote control scheduling system and a method in which previously registering a schedule for remote control of a plurality of display devices connected through a network and remotely controlling the display devices automatically according to the registered schedule is possible.

According to an aspect of the present invention, there is provided a remote control scheduling system including: a remote control scheduling server transmitting a predetermined remote control command to a predetermined display device at a predetermined time with reference to scheduling information on one or more display devices connected through a network; and one or more display devices executing the remote control command when receiving the remote control command from the remote control scheduling server.

According to another aspect of the present invention, there is provided a remote control scheduling server including: a scheduling database storing the scheduling information including remote control commands and control times for controlling one or more display devices; a user interface receiving the scheduling information and storing the received scheduling information in the scheduling database; and a scheduler for transmitting a predetermined remote control command to a predetermined display device with reference to the scheduling database.

The user interface may include an interface displaying existing scheduling information and allowing a user to edit the scheduling information or input new scheduling information.

The scheduling information may include a remote control command to change an input source of the display devices.

The remote control scheduling server may further include a status information analyzer analyzing status information on the display device transmitted from the display devices and outputting the analyzed status information to the user interface.

According to another aspect of the present invention, there is provided a display device including: a remote control command manager for receiving a remote control command scheduled from a remote server; and a MICOM controller controlling the display device by executing the remote control command received by the remote control command manager.

According to another aspect of the present invention, there is provided a remote control scheduling method for controlling one or more display devices connected through a network. The remote control scheduling method includes: reading scheduling information from a scheduling database for storing remote control commands and control time information for controlling the display devices; and transmitting a predetermined remote control command to a predetermined display device at a predetermined time with reference to the scheduling information.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing the construction of a network including a remote control scheduling server and display devices according to an exemplary embodiment of the present invention;

FIG. 2 is a block diagram showing the construction of a scheduling system for remotely controlling display devices according to an exemplary embodiment of the present invention;

FIG. 3 is a block diagram showing the construction of a scheduling system for remotely controlling display devices according to another exemplary embodiment of the present invention; and

FIG. 4 is a flow chart showing a scheduling method for remotely controlling display devices according to an exemplary embodiment of the present invention.

### DETAILED DESCRIPTION OF ILLUSTRATIVE, NON-LIMITING, EMBODIMENTS OF THE INVENTION

Exemplary embodiments of a scheduling system and a method for remotely controlling display devices will now be described in detail with reference to the accompanying drawings. The described exemplary embodiments are intended to assist the understanding of the invention, and are not intended to limit the scope of the invention in any way.

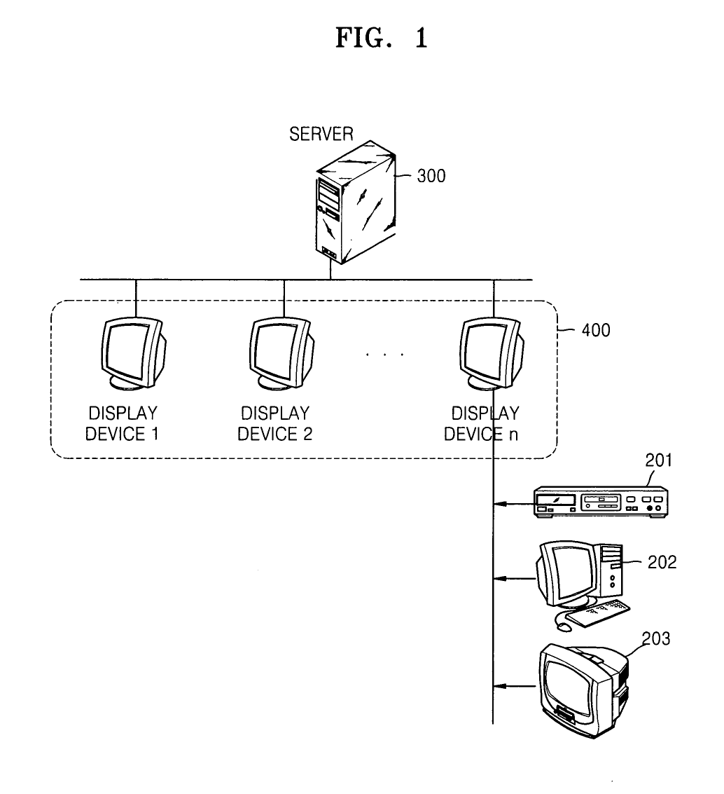

FIG. 1 is a block diagram showing the construction of a network including a remote control scheduling server 300 and display devices 400 according to an exemplary embodiment of the present invention. Referring to FIG. 1, a scheduling system for remotely controlling display devices according to the exemplary embodiment includes one or more display devices such as televisions, monitors, electronic bulletin boards, and so on, and a remote control scheduling server 300 for remotely controlling the display devices, connected through a network. The server 300 is connected to the display devices 400 in one network group through a network interface (not shown), and the server 300 and the display devices 400 are connected and registered in a manner defined by a network interface device. In addition, an input source such as a video 201, a personal computer 202, and a television antenna 203 may be connected to the display devices 400.

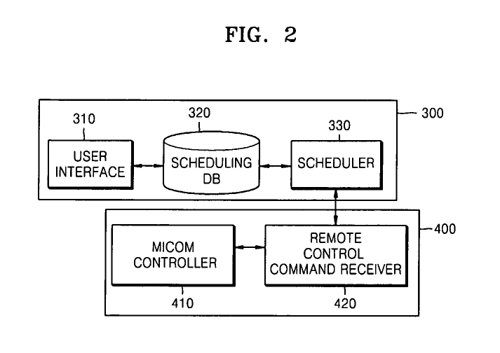

FIG. 2 is a block diagram showing the construction of a scheduling system for remotely controlling the display devices according to an exemplary embodiment of the present invention. Referring to FIG. 2, the scheduling system for remotely controlling the display devices according to the exemplary embodiment includes a remote control scheduling server 300 and display devices 400.

The remote control scheduling server 300 includes a user interface 310, a scheduling database (DB) 320, and a scheduler 330. The user interface 310 receives scheduling information from a user and stores the scheduling information in the scheduling DB 320. The user can change or delete the scheduling information by editing the scheduling information and input new scheduling information through the user interface 310. The scheduling DB 320 is a storage space for storing the scheduling information including control times and remote control commands for controlling a plurality of display devices 400 connected to the server 300. The scheduler 330 includes a timer (not shown) and transmits a predetermined remote control command to a predetermined display device at predetermined times.

The display devices 400 are clients of the remote control scheduling system, and each includes a MICOM controller 410 and a remote control command receiver 420. The remote control command receiver 420 receives the remote control command from the remote control scheduling server 300 through the network interface (not shown) and transmits the remote control command to the MICOM controller 410. The MICOM controller 410 is capable of controlling the display devices to execute the control command. The MICOM controller 410 performs power control, brightness control, and volume control according to the input control command. The scheduling function according to the exemplary embodiment operates at precise times with reference to the timer built into the remote control scheduling server 300, independently of an own reservation function of each display device.

For example, the following scheduling information can be stored in a display system installed in an airport.

10:00 power on display devices 1 and 2

start repeatedly playing a music file A.mp3 on the display devices 1 and 2

10:01 adjust volume of display devices 1 to 15

10:02 rotate display device 1 by 90 degrees to the right

10:03 change the input source of the display device 2 from DVI to S-Video

12:00 power off display devices 1 and 2

In this case, the remote control scheduling server 300 automatically transmits a corresponding control command at the time predetermined by the scheduling information and, if necessary, transmits multimedia content to the display devices 400. The MICOM controller 410 receives and executes the control command such as power control. According to the exemplary embodiment, as shown in the above example, the change of the input source of the display devices can be remotely controlled. In the above example, the input source is changed from the digital video interface (DVI) to the S-Video. In addition, the same schedule may be transmitted to a plurality of display devices at the same time, or a different schedule may be transmitted to each display device.

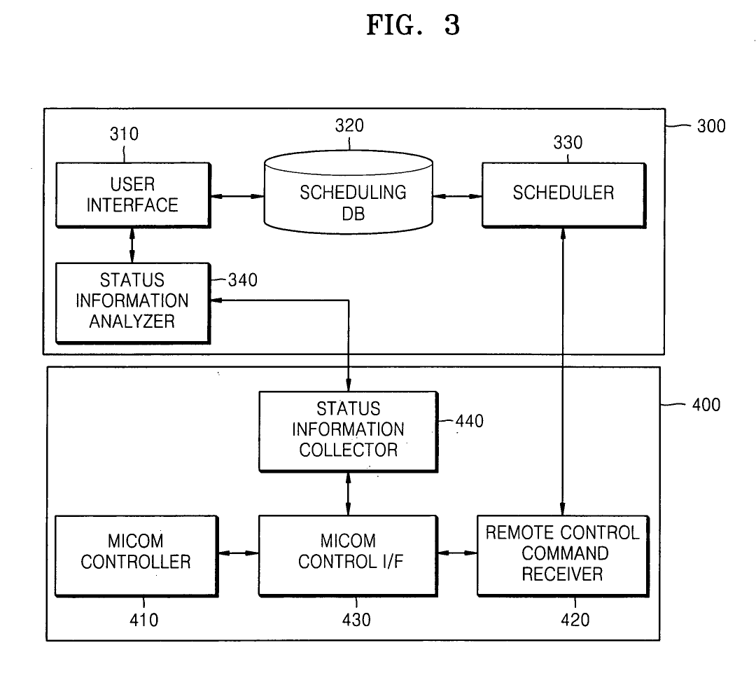

FIG. 3 is a block diagram showing the construction of a scheduling system for remotely controlling display devices according to another exemplary embodiment of the present invention.

Referring to FIG. 3, each display device 400 further includes a status information collector 440 which acquires status information on the display device and transmits the status information to the remote control scheduling server 300. The status information collector 440 refers to the MICOM controller 410 for the status of the display device, and can be embodied so as to transmit information to the MICOM controller 410 and receive information from the MICOM controller 410 through a MICOM control interface 430 which defines the interface with the MICOM controller 410 as shown. According to this exemplary embodiment, the remote control command receiver 420 converts the remote control command received by the server 300 into the format of the MICOM control interface 430 and then transmits the converted remote control command to the MICOM controller 410 through the MICOM control interface 430.

The remote control scheduling server 300 can include a status information analyzer 340 which analyzes the status information transmitted from the display device 400 and outputs the analyzed information to the user interface 310. According to this construction, the user can easily see the result of executing the remote control command or the current status of the display device 400 through the user interface 310.

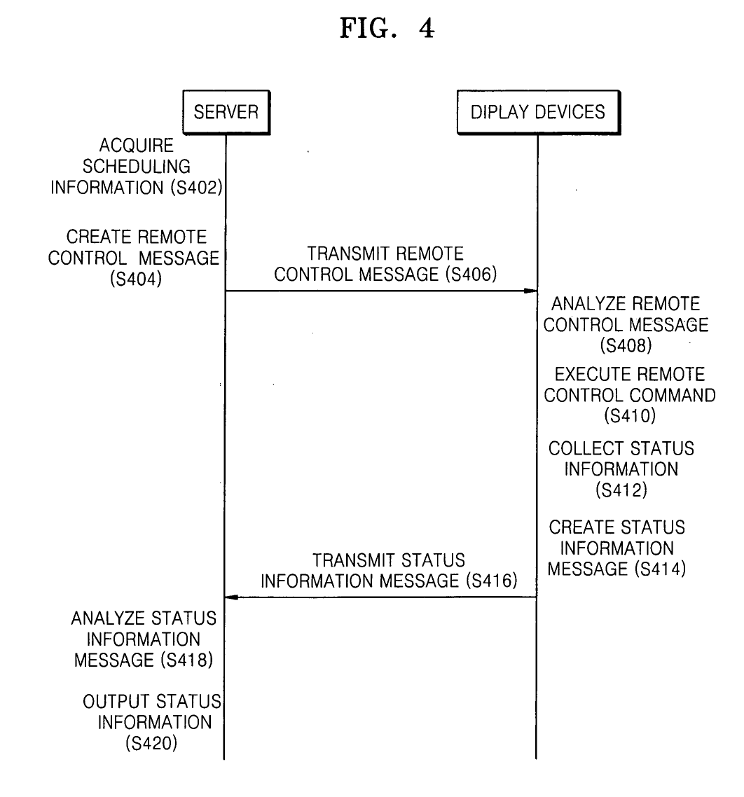

FIG. 4 is a flow chart showing a scheduling method for remotely controlling the display devices according to an exemplary embodiment of the present invention.

First, the remote server reads and acquires the scheduling information from the scheduling DB which stores identifiers of the display devices to be controlled, the remote control commands, the control time information, and so on (S402). The server converts the remote control command for controlling the corresponding display device with reference to the scheduling information to a message of the appropriate format, to create the remote control message (S404). Then, the server transmits the remote control message to the corresponding display device at the predetermined time (S406).

When receiving the remote control message, the display devices analyze the remote control message and determine what the remote control command is (S408). Then the display devices execute the remote control command (S410). The display devices can collect the status information of the display devices and transmit the collected information to the server so as to report the result of executing the control command or report the status of the display devices to the server according to the server's request. In this case, the status information of the display devices is acquired from the MICOM controller 410 (S412) and converted into a message of the appropriate format (S414), and then the converted message is transmitted to the server (S416).

When receiving the status information message, the server analyzes (S418) and outputs (S420) the status information message through the user interface.

The invention can also be embodied as computer readable code on a computer readable recording medium.

As described above, it is possible to reduce the time and the cost of controlling display devices by scheduling automatic control of the display devices, in a system including a plurality of display devices in advance. Time based management is possible without installing a timer in the display devices.

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences in scope will be construed as being included in the present invention.

What is claimed is:

1. A remote control scheduling system comprising:
a remote control scheduling server which transmits a predetermined remote control command to a predetermined display device at a predetermined time with reference to scheduling information on one or more display devices connected through a network; and
one or more display devices which executes the remote control command when receiving the remote control command from the remote control scheduling server.

2. A remote control scheduling server which transmits a predetermined remote control command to a predetermined display device at a predetermined time with reference to scheduling information on one or more display devices connected through a network.

3. The remote control scheduling server of claim 2, comprising:
a scheduling database which stores scheduling information including remote control commands and control times for controlling the display devices;
a user interface which receives the scheduling information and stores the received scheduling information in the scheduling database; and
a scheduler which transmits the predetermined remote control command to the predetermined display device with reference to the scheduling database.

4. The remote control scheduling server of claim 3, wherein the user interface includes an interface displaying existing scheduling information and allowing a user to edit the scheduling information or input new scheduling information.

5. The remote control scheduling server of claim 4, wherein the scheduling information includes a remote control command for changing an input source of the display devices.

6. The remote control scheduling server of claim 5, further comprising a status information analyzer analyzing status information of the display devices transmitted from the display devices and outputting the analyzed status information to the user interface.

7. A display device comprising:
a remote control command manager which receives a scheduled remote control command from a remote server; and
a MICOM controller which controls the display device by executing the remote control command received by the remote control command manager.

8. The display device of claim 7, further comprising a status information collector which acquires status information on the display device from the MICOM controller and transmitting the acquired status information to the server.

9. The display device of claim 8, further comprising a MICOM control interface for which transmits information between the remote control command manager, the status information collector, and the MICOM controller.

10. A remote control scheduling method for controlling one or more display devices connected through a network, the remote control scheduling method comprising:
reading scheduling information from a scheduling database storing remote control commands and control time information for controlling the display devices; and
transmitting a predetermined remote control command to a predetermined display device at a predetermined time with reference to the scheduling information.

11. The remote control scheduling method of claim 10, further comprising receiving the scheduling information and storing the input scheduling information in the scheduling database.

12. The remote control scheduling method of claim 11, further comprising receiving and outputting the execution result of the transmitted remote control command and status information on the display devices.

13. A remote control scheduling method for controlling one or more display devices connected through a network, the remote control scheduling method comprising:
receiving a scheduled remote control command from a remote server;
controlling the display devices by executing the remote control command; and
transmitting the execution result of the remote control command to the remote server.

14. The remote control scheduling method of claim 13, further comprising collecting status information on the display devices and transmitting the collected status information to the remote server.

15. The remote control scheduling method of claim 14, further comprising:
analyzing the collected status information transmitted to the remote server; and
transmitting the analyzed status information to a user interface to display the current status of the display devices.
